(19) United States
(12) Patent Application Publication
(10) Pub. No.: US 2024/0212870 A1
(43) Pub. Date: Jun. 27, 2024

(54) EFFECTIVE COATING MORPHOLOGY TO PROTECT ZR ALLOY CLADDING FROM OXIDATION AND HYDRIDING

(71) Applicant: Westinghouse Electric Company LLC, Cranberry Township, PA (US)

(72) Inventors: Edward J. LAHODA, Edgewood, PA (US); Elwyn ROBERTS, Lugoff, SC (US); Benjamin R. MAIER, Pittsburgh, PA (US); Allan Wayne JAWORSKI, JR., Canonsburg, PA (US); Arash PARSI, Sarver, PA (US); Guoqiang WANG, Murrysville, PA (US); William A. BYERS, Murrysville, PA (US); Jorie WALTERS, Columbia, SC (US); Chona P. VALLENCOUR, Indian Land, SC (US); John Leo LYONS, Pittsburgh, PA (US); Luke CZERNIAK, North Huntingdon, PA (US); Roy J. MATWAY, Pittsburgh, PA (US); Gregory E. ROBERTS, Heron, MT (US); Kathryn E. METZGER, Columbia, SC (US); Jonathan WRIGHT, Västerås (SE); Luke C. OLSON, Columbia, SC (US); Denise ADORNO-LOPES, Västerås (SE)

(73) Assignee: Westinghouse Electric Company LLC, Cranberry Township, PA (US)

(21) Appl. No.: 18/069,864

(22) Filed: Dec. 21, 2022

(51) Int. Cl. G21C 3/07; G21C 21/02

(52) U.S. Cl. CPC G21C 3/07; G21C 21/02

(57) ABSTRACT

A coating for protecting a Zirconium alloy based layer of a nuclear fuel rod cladding is provided. The coating comprises a primary layer. A microstructure of the primary layer is comprised of a number of grains and is randomized. The primary layer is configured with a density of about 94.5% or greater. A cladding for a nuclear fuel rod and a method for producing a cladding for a nuclear fuel rod are also provided.

### GOVERNMENT SUPPORT

This invention was made with government support under Government Contract No. DE-NE00009033 awarded by the Department of Energy. The government has certain rights in the invention.

### BACKGROUND

Chromium based coatings are currently employed in Zirconium alloy based claddings for accident tolerant fuel applications. The conventional coatings can effectively slow oxidation and/or hydriding of the cladding at Beyond Design Basis Accident temperatures. However, the initial protection provided by the coatings may suffer after long term exposure thereof to coolant and/or repeated thermal cycles. Therefore, a need exists to develop alternative claddings and manufacturing methods thereof to optimize the reliability and cost of accident tolerant fuel without compromising cladding integrity at high temperatures.

### SUMMARY

The following summary is provided to facilitate an understanding of some of the innovative features unique to the aspects disclosed herein and is not intended to be a full description. A full appreciation of the various aspects disclosed herein can be gained by taking the entire specification, claims, and abstract as a whole.

In various aspects, a coating for protecting a Zirconium alloy based layer of a nuclear fuel rod cladding is disclosed. In some aspects, the coating comprises a primary layer. In some aspects, a microstructure of the primary layer is comprised of a number of grains and is randomized. In some aspects, the primary layer is configured with a density of about 94.5% or greater.

In various aspects, cladding for a nuclear fuel rod is disclosed. In some aspects, the cladding comprises a Zirconium alloy tube and a coating deposited onto an outer surface of the Zirconium alloy tube. In some aspects, the Zirconium alloy tube is configured to house an amount of nuclear fuel. In some aspects, the coating comprises a Chromium-based layer having a randomized grain structure and a density of at least 95%.

In various aspects, a method for producing a cladding for a nuclear fuel rod is disclosed. In some aspects, the method comprises providing a base layer for the cladding and protecting the base layer. In some aspects, the base layer is comprised of a Zirconium alloy. In some aspects, protecting the base layer comprises depositing a coating onto the base layer. In some aspects, the coating comprises a Chromium-based layer having a randomized microstructure and a density of about 95% or greater.

These and other objects, features, and characteristics of the present disclosure, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of any of the aspects disclosed herein.

### BRIEF DESCRIPTION OF THE DRAWINGS

The various aspects described herein, together with objects and advantages thereof, may best be understood by reference to the following description, taken in conjunction with the accompanying drawings as follows.

FIG. 1 illustrates a cross-sectional elevation view of a fuel assembly, according to at least one non-limiting aspect of the present disclosure.

FIG. 2 illustrates a cross-sectional view of a fuel rod, according to at least one non-limiting aspect of the present disclosure.

FIG. 3 is a cross-sectional schematic representation of a coating microstructure, according to at least one non-limiting aspect of the present disclosure.

FIG. 4 is a cross-sectional schematic representation of a coating on a cladding base layer, in accordance with at least one non-limiting aspect of the present disclosure.

FIG. 5 is a cross-sectional schematic representation of a coating on a cladding base layer, in accordance with at least one non-limiting aspect of the present disclosure.

FIG. 6 is a cross-sectional schematic representation of a coating on a cladding base layer, in accordance with at least one non-limiting aspect of the present disclosure.

FIG. 7 is a cross-sectional schematic representation of a coating on a cladding base layer, in accordance with at least one non-limiting aspect of the present disclosure.

FIG. 8 is a schematic representation of a coating microstructure, in accordance with at least one non-limiting aspect of the present disclosure.

FIG. 9 is a schematic representation of a fuel rod, in accordance with at least one non-limiting aspect of the present disclosure.

Corresponding reference characters indicate corresponding parts throughout the several views. The exemplifications set out herein illustrate various aspects of the present disclosure, in one form, and such exemplifications are not to be construed as limiting the scope of any of the aspects disclosed herein.

### DETAILED DESCRIPTION

Certain exemplary aspects of the present disclosure will now be described to provide an overall understanding of the principles of the composition, function, manufacture, and use of the compositions and methods disclosed herein. An example or examples of these aspects are illustrated in the accompanying drawing. Those of ordinary skill in the art will understand that the compositions, articles, and methods specifically described herein and illustrated in the accompanying drawing are non-limiting exemplary aspects and that the scope of the various examples of the present disclosure is defined solely by the claims. The features illustrated or described in connection with one exemplary aspect may be combined with the features of other aspects. Such modifications and variations are intended to be included within the scope of the present disclosure.

Reference throughout the specification to “various examples,” “some examples,” “one example,” “an example,” or the like, means that a particular feature, structure, or characteristic described in connection with the example is included in an example. Thus, appearances of the phrases “in various examples,” “in some examples,” “in one example,” “in an example,” or the like, in places throughout the specification are not necessarily all referring to the same example. Furthermore, the particular features, structures, or characteristics may be combined in any suitable manner in an example or examples. Thus, the particular features, structures, or characteristics illustrated or described in connection with one example may be combined, in whole or in part, with the features, structures, or characteristics of another example or other examples without limitation. Such modifications and variations are intended to be included within the scope of the present examples.

In the following description, like reference characters designate like or corresponding parts throughout the several views of the drawings. Also in the following description, it is to be understood that such terms as “forward,” “rearward,” “left,” “right,” “above,” “below,” “upwardly,” “downwardly,” and the like are words of convenience and are not to be construed as limiting terms.

As used herein, the term “density” refers to a relative density defining a ratio of a bulk density of a coating or a layer thereof, comprised of a material, to the reference density of the material. For example, as used in the Specification and the claims, in a coating having a density of about 90%, about 10% of the volume occupied by the coating is comprised of void volume and/or pore volume.

Those of ordinary skill in the art will understand that references to the term “radial” appearing in the Specification and the claims, in connection with a component of a grain geometry, are not necessarily limited by and/or related to other appearances of the term “radial” or any particular orientation of a coating layer containing the grain. Thus, the radial component of a grain geometry is not necessarily aligned with a radius of a cylindrical substrate coated with a layer containing the grain.

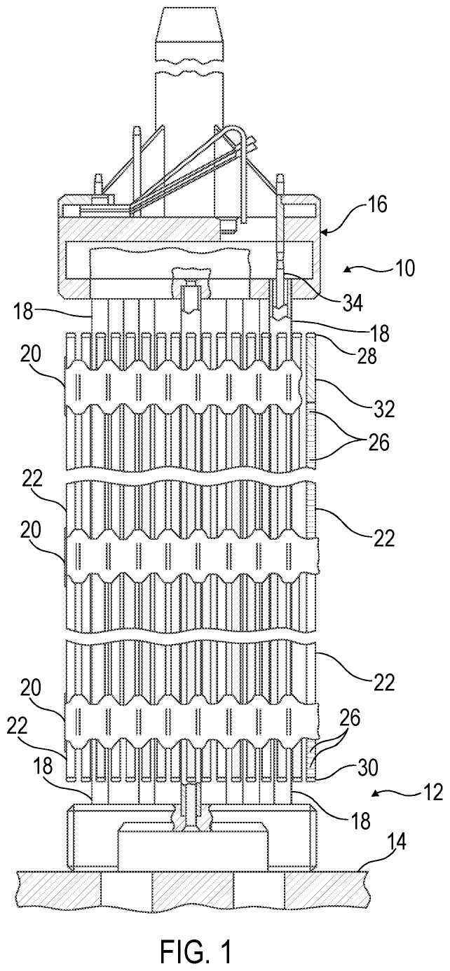

Generally, in a nuclear reactor, such as a pressurized water reactor (hereinafter referred to as “PWR”), heavy water reactor (e.g., a CANDU), or a boiling water reactor (hereinafter referred to as “BWR”), the reactor core can include a large number of fuel assemblies, each of which includes a plurality of elongated fuel elements or fuel rods. For example, FIG. 1 illustrates a cross-sectional elevation view of a fuel assembly 10, according to at least one non-limiting aspect of this disclosure. The fuel assembly 10 includes an organized array of elongated fuel rods 22. The fuel rods 22 can house a plurality of fuel pellets 26 each comprising a fissile material capable of sustaining a nuclear fission chain reaction, thereby generating heat.

The fuel rods 22 may be supported by one or more transverse grids 20 which attach to guide thimbles 18. The guide thimbles 18 extend longitudinally between top nozzle 16 and bottom nozzle 12 and are configured for control rods 34 to operably move therethrough. Opposite ends of the guide thimbles 18 can attach to the top nozzle 16 and bottom nozzle 12, respectively. The bottom nozzle 12 can be configured to support the fuel assembly 10 on a reactor vessel lower core plate 14 in the core region of a reactor. A liquid coolant such as water, or water including a neutron absorbing material such as boron, may be pumped to the fuel assembly 16 upwardly through a plurality of flow openings in the lower core plate 14. The bottom nozzle 12 of the fuel assembly 10 may pass the coolant flow to and along the fuel rods 22 of the fuel assembly 10 in order to extract heat generated as a result of the fission reactions occurring therein.

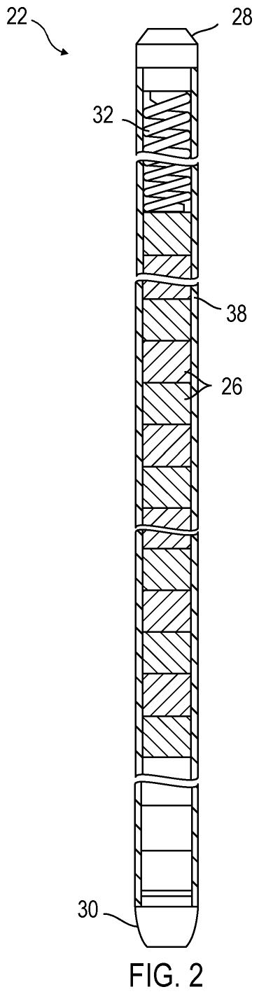

FIG. 2 illustrates a schematic cross-sectional view of a fuel rod 22, according to at least one non-limiting aspect of this disclosure. Referring now to FIGS. 1-2, as mentioned hereinabove, each of the fuel rods 22 may include a plurality of nuclear fuel pellets 26. The fuel pellets 26 are housed within an elongated cladding 38 tube that is closed at opposite ends by an upper end plug 28 and a lower end plug 30. The pellets 26 may be maintained in a stack by a plenum spring 32 disposed between the upper end plug 28 and the top of the pellet stack. However, in other implementations, the pellets 26 may be otherwise configured via alternate mechanisms.

Claddings typically employ materials having a low neutronic penalty and corrosion resistance in various reactor environment conditions. For example, Zirconium (“Zr”) alloy has been adopted as a standard material for claddings typically employed in nuclear fuel assemblies for PWRs. Under low temperature reactor operating conditions, such as, for example, at temperatures of about 500° C. or less, a Zr-alloy cladding can be exposed to coolant without compromising cladding properties, such as, for example, structural integrity and/or overall heat transfer characteristics, via oxidation and/or hydriding embrittlement. However, Zr-alloy based claddings may require protective surface treatments depending on reactor environments and/or operating conditions.

Accident Tolerant Fuel (“ATF”) has been developed to enhance the protection of nuclear fuel under unexpectedly high operating temperatures and/or accident conditions. For example, claddings in ATFs can incorporate Chromium (hereinafter referred to as “Cr”) coatings which are compatible with PWR and/or CANDU reactor chemistries and accident environments, and are fairly inexpensive to apply onto Zr-alloys. The deposition of the Cr coating can decrease the oxidation and/or hydriding rate of the cladding surface at Beyond Design Basis Accident (“BDBA”) temperatures, such as, for example, temperatures greater than 1200° C. However, while Cr is very compatible with reactor environments of PWR type reactors, Cr is not compatible with normal operation BWR chemistry. Furthermore, although ATFs employ relatively thin coatings having thicknesses of less than about 100 microns, the coatings may still increase the net neutronic penalty of the produced cladding, thereby compromising nuclear fuel efficiency and/or burnup efficiency. For example, Cr-based materials are known to have a relatively high neutron capture cross section area and therefore, Cr-based coatings should not be made overly thick to provide increased protection.

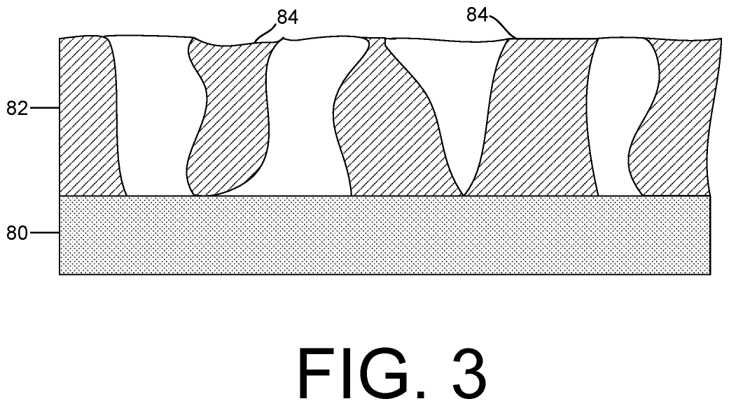

Coatings for ATFs can be applied onto Zr-based substrates with various Physical Vapor Deposition (“PVD”) techniques, such as, for example, Cathodic Arc (“CA”), Magnetron Sputtering (“MS”), and/or High-Power Impulse Magnetron Sputtering (“HiPIMS”), which are known to provide adherent Cr-based coatings having predictable, columnar microstructures. For example, FIG. 3 illustrates a cross-sectional schematic representation of a portion of a cylindrical Zr-alloy tube 80 and a coating layer 82 according to at least one non-limiting aspect of the present disclosure. The coating layer 82 has a columnar microstructure comprised of a number of radially oriented grains 84. The length of each of the grains 84 can span the thickness of the coating. Since each of the grains 84 of the columnar microstructure is similarly oriented, each of the grain boundaries is also similarly aligned and spans the thickness of the coating without any unpredictable changes in direction and/or orientation.

Columnar grains of a Cr-based coating deposited with a PVD technique, for example, are typically elongated and can have a mean diameter in the range of about 100 nanometers to about 10 microns depending on the employed technique and/or process parameters thereof. For example, MS is known to produce larger micron-scale columnar grains while HiPIMS typically produce a very fine grained microstructures having grains with a mean diameter of less than 1 micron. Research has shown that these relatively small, densely packed, columnar grains deposited with HiPIMS may protect an underlying Zr-alloy during a short term exposure to accident conditions such as, for example, a period of up to about 1 minute, or to consistent normal conditions analogous to a normal reactor environment for periods of up to about 60 days.

However, in contrast to research conditions, coatings relying on a columnar microstructure may not provide adequate protection in real world conditions where fuel assemblies can be undergoing fission for a period of up to about 6 years. While the fuel assemblies are in service, the claddings contained therein undergo many shrinking and expansion cycles due to transients and various inconsistencies in reactor environments. Since the grains in a coating employing a columnar microstructure are oriented substantially normal to the underlying substrate, the grain boundaries can provide a diffusion pathway between the Zr—Cr interface of a Cr-based coating for an ATF and the surrounding coolant, thereby facilitating hydriding and/or corrosion of the Zr and/or delamination of the Cr-based coating over time, which undermines the protective function of the Cr-based coating. For example, coolants for PWRs typically have a hydrogen content of about 2 to 7 parts per million which can diffuse along a columnar grain boundary of the Cr-based coating toward the Zr layer. Additionally, the inventors of the present disclosure have determined that a coating having a columnar microstructure can develop undesirable microstructural defects upon exposure to stresses associated with repeated expansion and contraction cycles. For example, cracks may propagate more easily towards a substrate over time in a columnar microstructure due to the normal orientation of each of the columnar grains with respect to the substrate, thereby inviting further coolant intrusion.

While HiPIMS parameters, such as, for example, target current, magnetron geometry, target material composition, surface conditions and/or pulse duration, can be manipulated to produce other grain structures, the resulting microstructures have a very high interfacial area due to the fine nanometer scale grains produced by HiPIMS techniques and therefore, are still susceptible to undesirable intrusion of oxidizing and/or hydriding agents via diffusion. Accordingly, various aspects of the present disclosure provide various methods and devices for protecting Zr-based claddings from oxidation and/or hydriding, for example, and maintaining coating integrity under extended service and/or accident conditions.

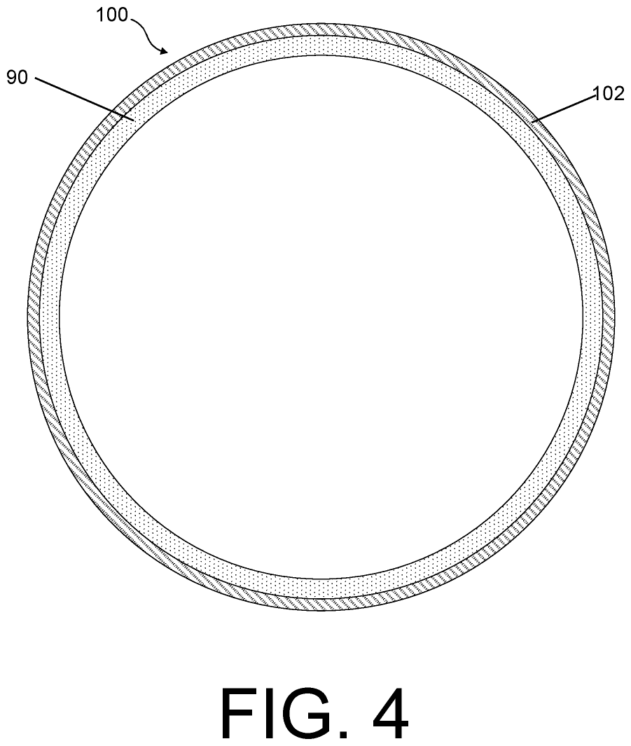

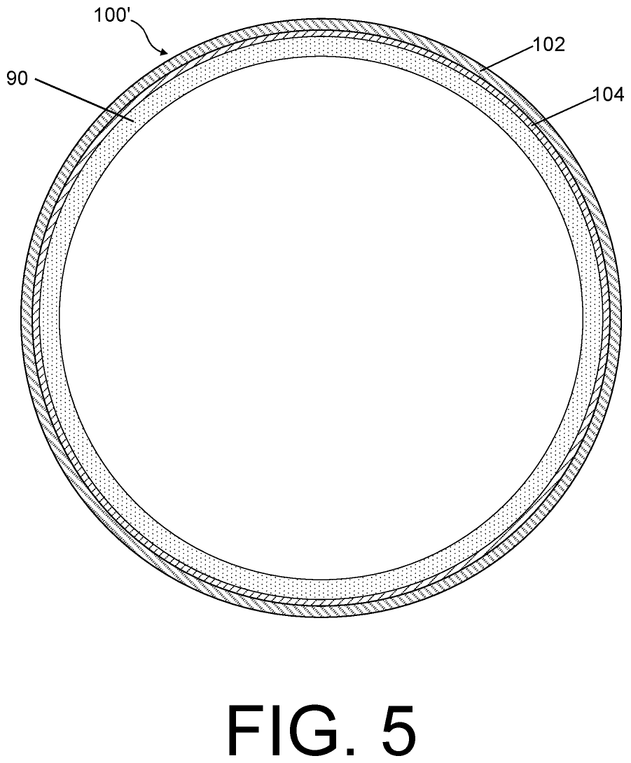

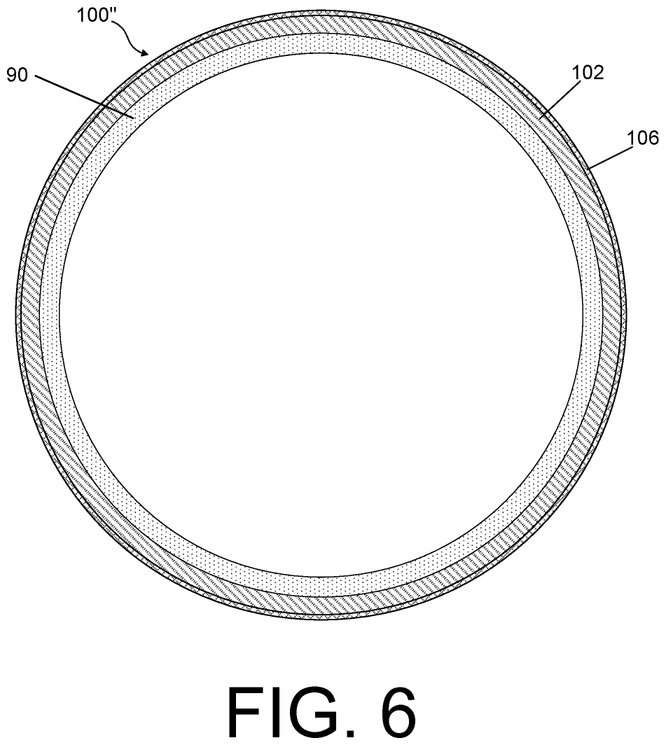

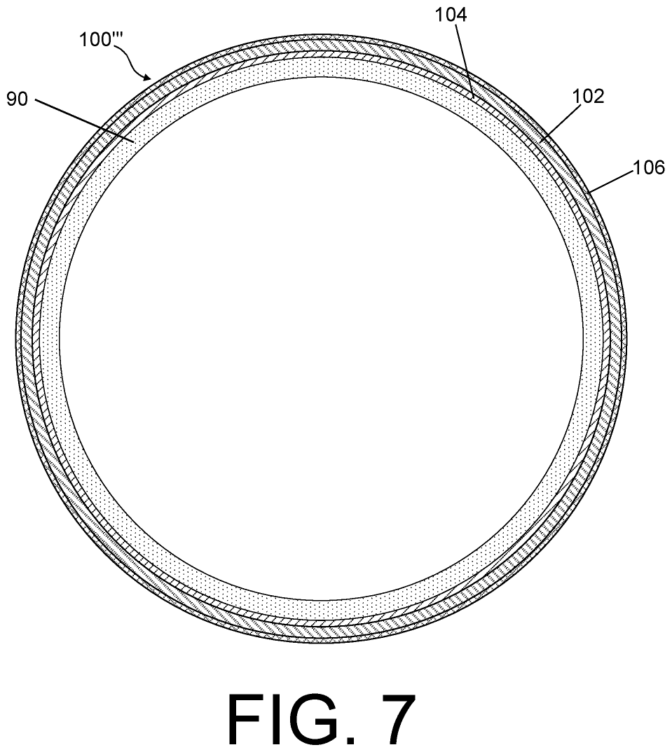

Now referring to FIG. 4, a cross-sectional schematic representation of a coating 100 for protecting a Zr alloy based layer 90 of a nuclear fuel rod is provided, in accordance with at least one non-limiting aspect of the present disclosure. In various examples, the coating 100 includes a primary layer 102. In some examples, the thickness of the primary layer 102 can be in the range of about 4 microns to about 40 microns. In other embodiments, the coating 100 can comprise multiple layers. For example, FIGS. 5-7 illustrate various examples of coatings including the primary layer 102 and one or more additional layers. FIG. 5 depicts a coating 100′ including an interlayer 104 under a primary layer 102 and FIG. 6 depicts a coating 100″ including a primary layer 102 surrounded by an outer layer 106. FIG. 7 depicts a coating 100″ including layers 102, 104, and 106.

Now referring to FIGS. 4-7, the primary layer 102 can be comprised of a metallic material. In some examples, the primary layer 102 can be comprised of a Cr-based metallic material. In certain examples, the primary layer 102 can be comprised of a Cr-based alloy. In examples where the primary layer 102 is comprised of a Cr-based alloy, the Cr-based alloy can include Yttrium or Molybdenum. A primary layer 102 incorporating this configuration can impart corrosion resistance onto an underlying Zr-alloy substrate intended for exposure to coolant and/or high temperature environments. Other compositions of the primary layer 102 are contemplated by the present disclosure. For example, in some implementations, the primary layer 102 is comprised of a ceramic or ceramic like material including Zirconia or a ceramic or ceramic like material including at least one of Chromium, Niobium, a nitride thereof, a silicide thereof, a carbide thereof, or a combination thereof.

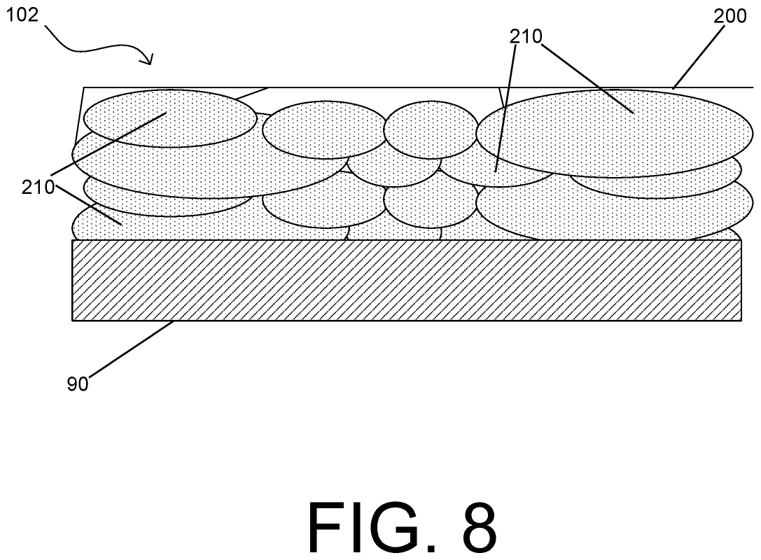

FIG. 8 provides a schematic microstructural representation of the primary layer 102 according to at least one non-limiting aspect of the present disclosure. In various examples, the primary layer 102 includes a microstructure 200 comprised of a number of grains 210 and is randomized. As used herein, the term “randomized” is used in reference to a configuration, size, shape, and/or positioning of a grain 210 with respect to a neighboring grain. Thus, the grains 210 and the grain boundaries formed therewith can be arranged in the microstructure 200 without any particular periodicity or orientation. Additionally, the crystal structure, size and/or geometry of each of the number of grains 210 can be randomized. For example, an average cross-sectional axial and/or radial component of each of the grains 210 can differ from that of a neighboring grain. In some examples, the geometry of each of the grains 210 can include an axial component in the range of about 1 micron to about 50 microns and a radial component in the range of about 1 micron to about 10 microns. In certain examples, at least some of the grains can be equiaxed.

Still referring to FIG. 8, the microstructure 200 can be configured to provide an optimized primary layer 102 density. For example, the radial and/or axial components of the dimensions of the grains 210 can be configured to be less than the thickness of the primary layer 102 to allow for grain stacking with at least some of the grains 210 being equiaxed. This configuration of grains 210 can be incorporated into a microstructure 200 to minimize excessive void volume between neighboring grains. Accordingly, a randomized microstructure 200 incorporating this configuration of grains 210 can provide a primary layer 102 density of at least 94.5% throughout the thickness of the primary layer 102 without relying on sub-micron grains and/or finely arranged columnar grains. In some examples, the primary layer 102 is configured with a density of at least 95%.

It has been found by the present inventors that a primary layer 102 configured with a randomized microstructure 200 and a density of about 95% or greater can significantly reduce the likelihood of any linked porosity within the coating 100, increase the tortuosity of a diffusion pathway through a coating 100 and/or inhibit any crack propagation through the coating 100. In some aspects, a coating 100 incorporating this configuration is deposited onto a Zr-alloy based layer of a nuclear fuel rod cladding to provide long term robust protection from corrosion and/or hydriding of the Zr-alloy by inhibiting any infiltration of coolant and/or other species dissolved in the coolant from the reactor environment into the underlying Zr-alloy. Moreover, in examples of the coating 100 including multiple layers, one or more of the layers can be configured with a randomized microstructure to provide the advantages associated therewith as described hereinabove.

Now referring back to FIGS. 5 and 7, the interlayer 104 can be configured to inhibit a chemical interaction between the primary layer 102 and an underlying Zr-alloy surface. For example, the composition of the interlayer can be configured with a material having a eutectic formation temperature with Zr and/or Cr greater than 1500° C. or greater than 1600° C., or greater than 2000° C., or greater than a BDBA temperature. In some examples, the coating 100 can include an interlayer 104 comprised of Niobium, Molybdenum, Tantalum, Rhenium, Osmium, Ruthenium, Tungsten, or an alloy comprising any combination thereof. An interlayer 104 incorporating this configuration can suppress Cr migration from the primary layer 102 to the Zr-alloy substrate during transient spikes in operating temperature or at high temperature conditions, such as, for example, BDBA conditions. Thus, an interlayer 104 incorporating this configuration can be applied onto a Zr-alloy based layer 90 to avoid a formation of a low melting eutectic Cr—Zr layer and/or intermetallic Zr—Cr compounds at high temperature and/or accident conditions, thereby increasing the ballooning and/or bursting resistance of the Zr-alloy based layer 90 at relatively high transient and/or accident condition temperatures. In certain examples, the interlayer 104 can have a thickness in the range of about 0.5 to about 4 microns. In one example, the interlayer 104 is configured with a randomized microstructure.

Now referring to FIGS. 6-7, the top layer 106 can be configured to provide the enhanced protection of an ATF in BDBA, high temperature, and/or normal operating conditions. For example, the top layer 106 can be comprised of a Cr-alloy or a ceramic material. In some examples, the top layer 106 can be comprised of a Cr-alloy including at least one of Yttrium, Molybdenum, Iron or Aluminum. In certain examples, the top layer 106 is configured as a Cr-alloy including Yttrium or Molybdenum or a Chromium alloy including Iron and/or Aluminum. In one example, the top layer 106 is configured with a randomized microstructure. In examples where the top layer 106 is comprised of a ceramic material, the top layer 106 can include Chromium, Nitrogen, Niobium, or any combination thereof. These alloys and ceramics are known to tolerate coolant having an O₂ content, such as, for example, up to about 10 ppm O₂. Thus, a coating 100 including a top layer 106 can be configured to provide protection from excessive corrosion in a BWR application.

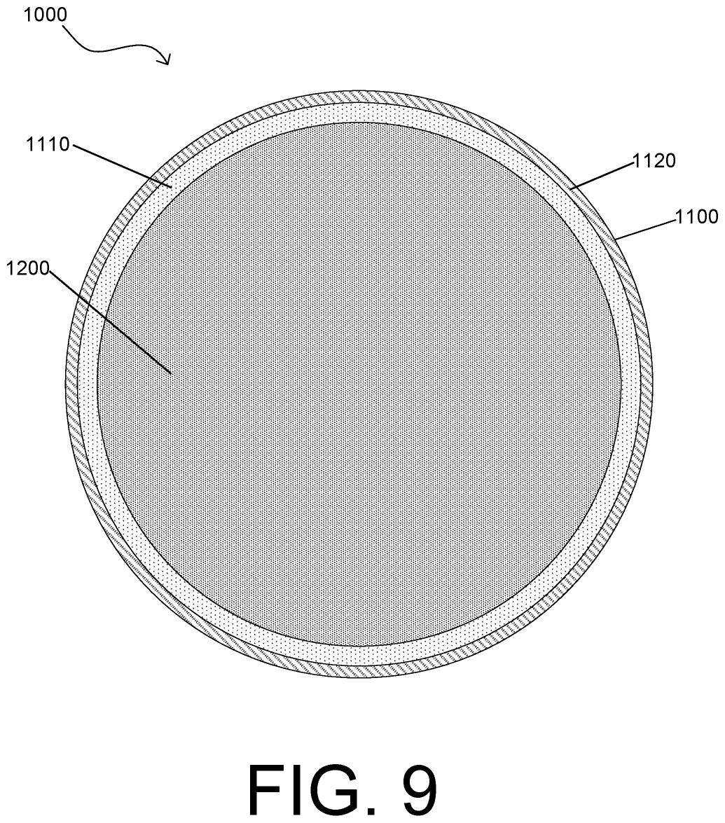

Now referring to FIG. 9, a cross-sectional schematic representation of a cladding 1100 for a nuclear fuel rod 1000 is provided in accordance with at least one non-limiting aspect of the present disclosure. In various examples, the cladding 1100 includes a Zr-alloy tube 1110 and a coating 1120 deposited onto an outer surface of the Zr-alloy tube 1110. In some examples, the Zr-alloy tube 1110 is a cylindrical tube defining a cavity therein. The Zr-alloy tube 1110 is configured to house an amount of nuclear fuel 1200. For example, if the nuclear fuel 1200 is in the form of a cylindrical pellet, the Zr-alloy tube 1110 can be configured with an inner diameter substantially the same as, or slightly larger than, an outer diameter of the nuclear fuel 1200. In one example, the inner diameter of the Zr-alloy tube 1110 is about 0.0007 inches larger than the outer diameter of the nuclear fuel 1200.

In various examples, the coating 1120 includes a Cr-based layer. The Cr-based layer of the coating 1120 can be configured similarly to a primary layer 102 as described hereinabove. Thus, the Cr-based layer of the coating 1120 can be configured with a corrosion resistant material, a randomized microstructure and a density of at least 95% to provide an increased resistance to corrosion and/or hydriding of the Zr-alloy tube 1110 and/or delamination of the coating 1120.

The coating 1120 can be configured similarly to a coating 100 as described hereinabove. Thus, the coating 1120 can include an interlayer and/or an outer layer configured similarly to, respectively, an interlayer 104 and an outer layer 106 as described hereinabove. Accordingly, the coating 1120 can be configured to increase the ballooning and/or bursting resistance of the Zr-alloy tube 1110 at relatively high transient and/or accident condition temperatures and/or provide protection from excessive corrosion in a BWR application. In some examples, the coating 1120 can include multiple layers having a randomized microstructure.

As discussed herein, a method for producing a cladding for a nuclear fuel rod is provided by the present disclosure. The method includes providing a base layer comprised of a Zr-alloy for the cladding and protecting the base layer. In various examples of the method, the step of protecting the base layer includes depositing a coating comprising a Cr-based layer onto the base layer. In some examples, protecting the base layer can include depositing an interlayer prior to depositing the Cr-based layer and/or depositing an outer layer onto the Cr-based layer. The coating of the method is similar in many respects to other coatings described elsewhere in the present disclosure which are not repeated for the sake of brevity. Thus, the Cr-based layer can include a microstructure comprised of a number of grains. Additionally the interlayer and the outer layer of the method can be configured similarly to other interlayers and outer layers, respectively, as described hereinabove. Accordingly, the method as described herein can be configured to provide long term, robust protection from corrosion and/or hydriding of the Zr-alloy base layer of the cladding in accident conditions and/or BWR environments.

The step of protecting the base layer can be configured to provide a coating layer having a randomized microstructure and a density of about 94.5% or greater. For example, the Cr-based layer of the coating can be deposited with a cold spray process. The present inventors have determined that a cold spray process can be employed to deposit a Cr-based layer having randomized grain boundaries with many sub-grains throughout the coating thickness. For example, a cold spray process for depositing the Cr-based layer can include forming a mixture comprising preheated carrier gas and Cr-based particles, and subsequently spraying the mixture onto a substrate at a particle velocity in the range of about 240 meters/second to about 1220 meters per second until a desired thickness is achieved. In some examples, the cold spray process for depositing the Cr-based layer includes adding Cr-based particles having an average diameter in the range of about 10 microns to about 500 microns to Helium and/or Nitrogen based carrier gas stream preheated to a temperature in the range of about 200° ° C. to about 1200° C. Other configurations of the deposition process are contemplated by the present disclosure. For example, in some implementations, a coating layer can be deposited with a thermal spray process or a PVD process. Additionally, protecting the base layer can include thermomechanical treatments of a deposited layer of the coating. In certain examples, the method can include a cold working step of a deposited layer based on swaging, pilgering, shot peening, and/or laser shock peening and a subsequent annealing step.

The thermomechanical treatments can be configured to modify grain size and/or structure of a deposited layer as required to further increase the density of a given layer of the coating. For example, if the grains of a deposited layer are fairly equiaxed and the layer is many grains thick already, the cold working step can be configured to impart a series of low to moderate strains in the range of about 6% to about 7% onto the deposited layer, followed by a lower temperature annealing step configured to induce recovery in the grain structure.

In other instances where the grains of a deposited layer are too large and/or columnar, the thermomechanical treatments can be configured to modify the grain structure to provide a more equiaxed structure. For example, the thermomechanical treatments can include higher degrees of cold work to provide strains in the range of 30% or greater, followed by a high temperature annealing step configured to induce recrystallization in the grain structure. Thus, the protecting step of the method described herein can be configured to modify a microstructure of a deposited coating layer thereby providing an increase in the density of a coating layer and/or mitigating any porous or undesirable high energy grain boundaries. Accordingly, the method for producing a cladding can be configured to optimize the level of protection provided by a coating.

Various aspects of the present disclosure include, but are not limited to, the aspects listed in the following numbered clauses.

Clause 1—A coating for protecting a Zirconium alloy based layer of a nuclear fuel rod cladding. The coating comprises a primary layer. A microstructure of the primary layer is comprised of a number of grains and is randomized. The primary layer is configured with a density of about 94.5% or greater.

Clause 2—The coating of clause 1, wherein the primary layer has a thickness in the range of about 4 microns to about 40 microns.

Clause 3—The coating of any one of clauses 1-2, wherein the primary layer comprises a Chromium-based metallic layer.

Clause 4—The coating of clause 3, wherein the Chromium-based metallic layer is comprised of a Chromium-based alloy.

Clause 5—The coating of any one of clauses 1-4, wherein the coating comprises a ceramic layer.

Clause 6—The coating of clause 5, wherein the ceramic layer is comprised of Zirconium Dioxide or a Chromium-based material comprising at least one of Niobium, Nitrogen, Silicon, or Carbon.

Clause 7—The coating of any one of clauses 1-6, wherein the ceramic layer is the primary layer.

Clause 8—The coating of any one of clauses 1-6, wherein the ceramic layer is positioned around the primary layer.

Clause 9—The coating of clause 8, wherein the ceramic layer has a thickness in the range of about 1 micron to about 10 microns.

Clause 10—The coating of clause 8, wherein the ceramic layer is configured with a density of about 94.5% or greater.

Clause 11—The coating of any one of clauses 1-10, wherein the coating comprises an interlayer positioned between the Zirconium alloy based layer and the primary layer.

Clause 12—The coating of clause 11, wherein the interlayer has a thickness in the range of about 0.5 to about 4 microns.

Clause 13—The coating of any one of clauses 11-12, wherein the interlayer is configured to inhibit a chemical interaction between the Zirconium alloy and the primary layer.

Clause 14—The coating of any one of clauses 11-13, wherein the interlayer is comprised of Niobium, Molybdenum, Tantalum, Rhenium, Osmium, Ruthenium, Tungsten, or an alloy comprising any combination thereof.

Clause 15—The coating of any one of clauses 1-14, wherein the primary layer is configured with a density of at least 95%.

Clause 16—The coating of any one of clauses 1-15, wherein the geometry of each of the number of grains comprises an axial component in the range of about 1 micron to about 50 microns and a radial component in the range of about 1 micron to about 10 microns.

Clause 17—A cladding for a nuclear fuel rod. The cladding comprises a Zirconium alloy tube and a coating deposited onto an outer surface of the Zirconium alloy tube. The Zirconium alloy tube configured to house an amount of nuclear fuel. The coating comprises a Chromium-based layer. The Chromium-based layer has a randomized grain structure and a density of at least 95%.

Clause 18—A method for producing a cladding for a nuclear fuel rod. The method comprises providing a base layer for the cladding and protecting the base layer. The base layer is comprised of a Zirconium alloy. Protecting the base layer further comprises depositing a coating onto the base layer. The coating comprises a Chromium-based layer. The Chromium-based layer of the protected base layer has a randomized microstructure and a density of about 95% or greater.

Clause 19—The method of clause 18, wherein the protecting comprises depositing the Chromium-based layer with a cold spray process, a thermal spray process, or a Physical Vapor Deposition process.

Clause 20—The method of any one of clauses 18-19, wherein the protecting comprises mechanically working the deposited at least one layer.

Various features and characteristics are described in this specification to provide an understanding of the composition, structure, production, function, and/or operation of the disclosure, which includes the disclosed methods and systems. It is understood that the various features and characteristics of the disclosure described in this specification can be combined in any suitable manner, regardless of whether such features and characteristics are expressly described in combination in this specification. The Inventors and the Applicant expressly intend such combinations of features and characteristics to be included within the scope of the disclosure described in this specification. As such, the claims can be amended to recite, in any combination, any features and characteristics expressly or inherently described in, or otherwise expressly or inherently supported by, this specification. Furthermore, the Applicant reserves the right to amend the claims to affirmatively disclaim features and characteristics that may be present in the prior art, even if those features and characteristics are not expressly described in this specification. Therefore, any such amendments will not add new matter to the specification or claims and will comply with the written description, sufficiency of description, and added matter requirements.

With respect to the appended claims, those skilled in the art will appreciate that recited operations therein may generally be performed in any order. Also, although various operational flows are presented in a sequence(s), it should be understood that the various operations may be performed in other orders than those that are illustrated or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

The invention(s) described in this specification can comprise, consist of, or consist essentially of the various features and characteristics described in this specification. The terms “comprise” (and any form of comprise, such as “comprises” and “comprising”), “have” (and any form of have, such as “has” and “having”), “include” (and any form of include, such as “includes” and “including”), and “contain” (and any form of contain, such as “contains” and “containing”) are open-ended linking verbs. Thus, a method or system that “comprises,” “has,” “includes,” or “contains” a feature or features and/or characteristics possesses the feature or those features and/or characteristics but is not limited to possessing only the feature or those features and/or characteristics. Likewise, an element of a composition, coating, or process that “comprises,” “has,” “includes,” or “contains” the feature or features and/or characteristics possesses the feature or those features and/or characteristics but is not limited to possessing only the feature or those features and/or characteristics and may possess additional features and/or characteristics.

The grammatical articles “a,” “an,” and “the,” as used in this specification, including the claims, are intended to include “at least one” or “one or more” unless otherwise indicated. Thus, the articles are used in this specification to refer to one or more than one (i.e., to “at least one”) of the grammatical objects of the article. By way of example, “a component” means one or more components and, thus, possibly more than one component is contemplated and can be employed or used in an implementation of the described compositions, coatings, and processes. Nevertheless, it is understood that use of the terms “at least one” or “one or more” in some instances, but not others, will not result in any interpretation where failure to use the terms limits objects of the grammatical articles “a,” “an,” and “the” to just one. Further, the use of a singular noun includes the plural, and the use of a plural noun includes the singular, unless the context of the usage requires otherwise.

In this specification, unless otherwise indicated, all numerical parameters are to be understood as being prefaced and modified in all instances by the term “about,” in which the numerical parameters possess the inherent variability characteristic of the underlying measurement techniques used to determine the numerical value of the parameter. At the very least, and not as an attempt to limit the application of the doctrine of equivalents to the scope of the claims, each numerical parameter described herein should at least be construed in light of the number of reported significant digits and by applying ordinary rounding techniques.

Any numerical range recited herein includes all sub-ranges subsumed within the recited range. For example, a range of “1 to 10” includes all sub-ranges between (and including) the recited minimum value of 1 and the recited maximum value of 10, that is, having a minimum value equal to or greater than 1 and a maximum value equal to or less than 10. Also, all ranges recited herein are inclusive of the end points of the recited ranges. For example, a range of “1 to 10” includes the end points 1 and 10. Any maximum numerical limitation recited in this specification is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited. All such ranges are inherently described in this specification.

As used in this specification, particularly in connection with layers, the terms “on,” “onto,” “over,” and variants thereof (e.g., “applied over,” “formed over,” “deposited over,” “provided over,” “located over,” and the like) mean applied, formed, deposited, provided, or otherwise located over a surface of a substrate but not necessarily in contact with the surface of the substrate. For example, a layer “applied over” a substrate does not preclude the presence of another layer or other layers of the same or different composition located between the applied layer and the substrate. Likewise, a second layer “applied over” a first layer does not preclude the presence of another layer or other layers of the same or different composition located between the applied second layer and the applied first layer.

Whereas particular examples of this disclosure have been described above for purposes of illustration, it will be evident to those skilled in the art that numerous variations of the details of the present disclosure may be made without departing from the disclosure as defined in the appended claims.

What is claimed is:

1. A coating for protecting a Zirconium alloy based layer of a nuclear fuel rod cladding, the coating comprising a primary layer, wherein:
a microstructure of the primary layer is comprised of a number of grains and is randomized; and
the primary layer is configured with a density of about 94.5% or greater.

2. The coating as claimed in claim 1, wherein the primary layer has a thickness in the range of about 4 microns to about 40 microns.

3. The coating as claimed in claim 1, wherein the primary layer comprises a Chromium-based metallic layer.

4. The coating as claimed in claim 3, wherein the Chromium-based metallic layer is comprised of a Chromium-based alloy.

5. The coating as claimed in claim 1, wherein the coating comprises a ceramic layer.

6. The coating as claimed in claim 5, wherein the ceramic layer is comprised of Zirconium Dioxide or a Chromium-based material comprising at least one of Niobium, Nitrogen, Silicon, or Carbon.

7. The coating as claimed in claim 5, wherein the ceramic layer is the primary layer.

8. The coating as claimed in claim 5, wherein the ceramic layer is positioned around the primary layer.

9. The coating as claimed in claim 8, wherein the ceramic layer has a thickness in the range of about 1 micron to about 10 microns.

10. The coating as claimed in claim 8, wherein the ceramic layer is configured with a density of about 94.5% or greater.

11. The coating as claimed in claim 1, wherein the coating comprises an interlayer positioned between the Zirconium alloy based layer and the primary layer.

12. The coating as claimed in claim 11, wherein the interlayer has a thickness in the range of about 0.5 to about 4 microns.

13. The coating as claimed in claim 11, wherein the interlayer is configured to inhibit a chemical interaction between the Zirconium alloy and the primary layer.

14. The coating as claimed in claim 13, wherein the interlayer is comprised of Niobium, Molybdenum, Tantalum, Rhenium, Osmium, Ruthenium, Tungsten, or an alloy comprising any combination thereof.

15. The coating as claimed in claim 1, wherein the primary layer is configured with a density of at least 95%.

16. The coating as claimed in claim 1, wherein the geometry of each of the number of grains comprises:
an axial component in the range of about 1 micron to about 50 microns; and
a radial component in the range of about 1 micron to about 10 microns.

17. A cladding for a nuclear fuel rod, the cladding comprising:
a Zirconium alloy tube configured to house an amount of nuclear fuel; and
a coating deposited onto an outer surface of the Zirconium alloy tube, the coating comprising a Chromium-based layer, the Chromium-based layer having a randomized grain structure and a density of at least 95%.

18. A method for producing a cladding for a nuclear fuel rod, the method comprising:
providing a base layer for the cladding, wherein the base layer is comprised of a Zirconium alloy; and
protecting the base layer, the protecting comprising depositing a coating onto the base layer, wherein the coating comprises a Chromium-based layer; and
wherein the Chromium-based layer of the protected base layer has a randomized microstructure and a density of about 95% or greater.

19. The method as claimed in claim 18, wherein the protecting comprises depositing the Chromium-based layer with a cold spray process, a thermal spray process, or a Physical Vapor Deposition process.

20. The method as claimed in claim 18, wherein the protecting comprises mechanically working the deposited at least one layer.
